(19) United States
(12) Patent Application Publication
(10) Pub. No.: US 2023/0252497 A1
(43) Pub. Date: Aug. 10, 2023

(54) SYSTEMS AND METHODS FOR MEASURING IMPACT OF ONLINE SEARCH QUERIES ON USER ACTIONS

(71) Applicant: FMR LLC, Boston, MA (US)

(72) Inventors: Adam Young, Shrewsbury, MA (US); Ankush Chopra, Khairagarh (IN); Bibhash Chakrabarty, Bengaluru (IN); Abhishek Mansing Desai, Bengaluru (IN); Sohom Ghosh, Burdwan (IN); Henry Ortiz, Providence, RI (US); Anup Nayak, Bengaluru (IN); Sailesh Kumar Sankar Kumar, Chennai (IN)

(21) Appl. No.: 17/668,976

(22) Filed: Feb. 10, 2022

(51) Int. Cl. G06Q 30/02; G06F 16/9535; G06F 16/906

(52) U.S. Cl. CPC G06Q 30/0201; G06F 16/9535; G06F 16/906

(57) ABSTRACT

Systems and methods for measuring impact of online search queries on user actions. The method includes capturing clickstream data entered via a website, the clickstream data including text-based queries associated with web searches, and clustering the queries to generate query clusters. The method also includes assigning each query cluster to an intent such that each assigned intent estimates a desired action behind the queries in the corresponding query cluster. The method further includes mapping each intent assigned to a query cluster to at least one action motivated by the intent. The method also includes computing metrics using the mapping to quantitatively measure the impact of the queries on the mapped actions by tracking performance of the actions within a predefined time period after the queries.

### FIELD OF THE INVENTION

The present invention relates generally to systems and methods for capturing and analyzing clickstream data, including systems and methods for calculating metrics from clickstream data.

### BACKGROUND OF THE INVENTION

Many organizations use a search engine to allow users a systematic and easy way of discovering and locating specific information on the organization's website. The quality of the search engine can make or break the user experience on any website. There have been attempts at improving the speed and efficiency of search engines. However, an area that often gets overlooked is how to measure the impact of search results in tangible ways which lead to specific and measurable business outcomes.

For example, attempts have been made to gather feedback on the performance of search engines from customers through surveys or like-dislike buttons. However, very few customers respond to such explicit feedback requests, and tying such feedback to specific and measurable business outcomes can be difficult. Therefore, there is a need for a software tool that is able to use clickstream data to determine the impact of search results on user behavior after the search results have been presented to the user.

### SUMMARY OF THE INVENTION

Accordingly, an object of the invention is to provide systems and methods for measuring the impact of online search queries on customer actions. It is an object of the invention to provide systems and methods for capturing customer clickstream data including text-based queries and clustering the queries to generate query clusters. It is an object of the invention to provide systems and methods for assigning each query cluster to an intent and mapping each assigned intent to a customer action motivated by the intent. It is an object of the invention to provide systems and methods for computing metrics using the mapping to quantitatively measure the impact of the queries on the mapped customer actions.

In some aspects, a computerized method for measuring impact of online search queries on customer actions includes capturing customer clickstream data entered via a website, the customer clickstream data including text-based queries associated with customer web searches. The computerized method also includes clustering the queries to generate query clusters. The computerized method also includes assigning each query cluster to an intent of pre-defined intents, each assigned intent estimates a desired customer action behind the queries in the corresponding query cluster.

The computerized method further includes mapping each intent assigned to a query cluster to at least one customer action motivated by the intent, the mapping of each intent to the corresponding customer action further correlates the corresponding query cluster to the customer action. The computerized method also includes computing metrics using the mapping to quantitatively measure the impact of the queries on the mapped customer actions by tracking performance of the customer actions within a predefined time period after the queries.

In some embodiments, the computerized method includes expanding the query clusters by adding one or more new query clusters based on analysis of the customer clickstream data. For example, in some embodiments, expanding the query clusters includes analyzing the customer clickstream data to determine proximity of web pages and customer searches based on semantic similarity in an embedding space, grouping searches and web pages in near proximity to each other using a clustering algorithm to generate the one or more new query clusters, discovering new intents based on the one or more new query clusters, the new intents being different from the pre-defined intents, and adding the one or more new query clusters corresponding to the new intents to the query clusters corresponding to the predefined intents to expand the query clusters.

In some embodiments, clustering the queries includes cleaning and normalizing the text-based queries, numerically representing the cleaned and normalized text-based queries using an embedding creation technique to generate a plurality of embedding, and recursively clustering the plurality of embedding using a hierarchical clustering technique to generate the query clusters. For example, in some embodiments, cleaning the queries includes one or more of (i) removing non-informative phrases from the queries, (ii) expanding acronyms in the queries, (iii) removing repetitive words or phrases from the queries; and (iv) removing sensitive customer information from the queries.

In some embodiments, the computerized method includes transforming the embedding to create transformed embedding with numerical values in a range of 0 and 1 and reducing a number of dimensions of the transformed embedding using a principal component analysis technique, the recursive clustering being performed based on the transformed embedding with the reduced dimensionality.

In some embodiments, assigning each query cluster to an intent includes naming each query cluster after a highest-occurring search query in that query cluster and assigning the intent to the query cluster based on the name of the query cluster.

In some embodiments, the metrics include an engagement-to-action ratio numerically quantifying a success rate for completing a customer action within the predefined time period that corresponds to a mapped query. For example, in some embodiments, computing the engagement-to-action ratio includes tracking customers who completed the customer action within the predefined time period after performing the search query corresponding to the customer action and computing the engagement-to-action ratio as a percentage of a number of the customers who performed the corresponding search query and completed the customer action within the predefined time period relative to a number of the overall customers who performed the corresponding search query.

In some embodiments, the metrics include a service call rate that quantifies a frequency at which customers engage with a call center within a predefined time period following performing a search query assigned to a search query cluster. For example, in some embodiments, computing the service call rate includes tracking inbound calls from customers within the predefined time period for services related to the search query and computing the service call rate as a percentage of a number of the inbound calls within the predefined time period relative to a number of search queries in the assigned search query cluster.

In some aspects, a system for measuring the impact of online search queries on customer actions includes an input module configured to capture and process customer clickstream data entered via a website, the customer clickstream data including text-based queries associated with customer web searches. The system also includes an initial clustering module configured to (i) cluster the queries to generate query clusters and (ii) assign each query cluster to an intent of pre-defined intents. Each assigned intent estimates a desired customer action behind the queries in the corresponding query cluster.

The system also includes a workflow module configured to map each intent assigned to a query cluster to at least one customer action motivated by the intent. The mapping of each intent to the corresponding customer action further correlates the corresponding query cluster to the customer action. The system also includes a performance measurement module configured to compute metrics using the mapping to quantitatively measure the impact of the queries on the mapped customer actions by tracking performance of the customer actions within a predefined time period after the queries.

In some embodiments, the system includes a cluster expansion module configured to expand the query clusters by adding one or more new query clusters to the query clusters based on analysis of the customer clickstream data. For example, in some embodiments, the cluster expansion module expands the query clusters by analyzing the customer clickstream data to determine proximity of web pages and customer searches based on semantic similarity in an embedding space, grouping searches and web pages in near proximity to each other using a clustering algorithm to generate the one or more new query clusters, discovering new intents based on the one or more new query clusters, the new intents being different from the predefined intents, and adding the one or more new query clusters corresponding to the new intents to the query clusters corresponding to the predefined intents to expand query clusters.

In some embodiments, the initial clustering module clusters the queries by cleaning and normalizing the text-based queries, numerically representing the cleaned and normalized text-based queries using an embedding creation technique to generate a plurality of embedding, and recursively clustering the plurality of embedding using a hierarchical clustering technique to generate the query clusters.

In some embodiments, the initial clustering module assigns each query cluster to an intent by naming each query cluster after a highest-occurring search query in that query cluster and assigning the intent to the query cluster based on the name of the query cluster.

In some embodiments, the metrics include an engagement-to-action ratio numerically quantifying a success rate for completing a customer action within the predefined time period that corresponds to a mapped query. For example, in some embodiments, the performance measurement module is configured to compute the engagement-to-action ratio by tracking customers who completed the customer action within the predefined time period after performing the search query corresponding to the customer action and computing the engagement-to-action ratio as a percentage of a number of the customers who performed the corresponding search query and completed the customer action within the predefined time period relative to a number of the overall customers who performed the corresponding search query.

In some embodiments, the metrics include a service call rate that quantifies a frequency at which customers engage with a call center within a predefined time period following making a search query assigned to a search query cluster. For example, in some embodiments, the performance measurement module is configured to compute the service call rate by tracking inbound calls from customers within the predefined time period for services related to the search query and computing the service rate as a percentage of a number of the inbound calls within the predefined time period relative to a number of search queries in the assigned search query cluster.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network, according to embodiments of the technology described herein.

FIG. 2 is a block diagram of an exemplary server computing device and an exemplary user device, according to embodiments of the technology described herein.

FIG. 3 is a block diagram of an exemplary architecture for measuring the impact of online search queries on customer actions, according to embodiments of the technology described herein.

FIG. 4 is a block diagram of an exemplary initial query clustering module, according to embodiments of the technology described herein.

FIG. 5 is a block diagram of an exemplary cluster expansion module, according to embodiments of the technology described herein.

FIG. 6 is a block diagram of an exemplary customer workflows module, according to embodiments of the technology described herein.

FIG. 7 is a block diagram of an exemplary performance measurement module, according to embodiments of the technology described herein.

FIG. 8 is a flow diagram of a computer-implemented method for measuring the impact of online search queries on customer actions using the architecture of FIG. 3, according to embodiments of the technology described herein.

### DETAILED DESCRIPTION OF THE INVENTION

In some aspects, the systems and methods described herein can include one or more mechanisms or methods for measuring the impact of online search queries on customer actions. The systems and methods described herein can include mechanisms or methods for capturing customer clickstream data including text-based queries and clustering the queries to generate query clusters. The systems and methods described herein can include mechanisms or methods for assigning each query cluster to an intent and mapping each assigned intent to a customer action motivated by the intent. The systems and methods described herein can include mechanisms or methods for computing metrics using the mapping to quantitatively measure the impact of the queries on the mapped customer actions.

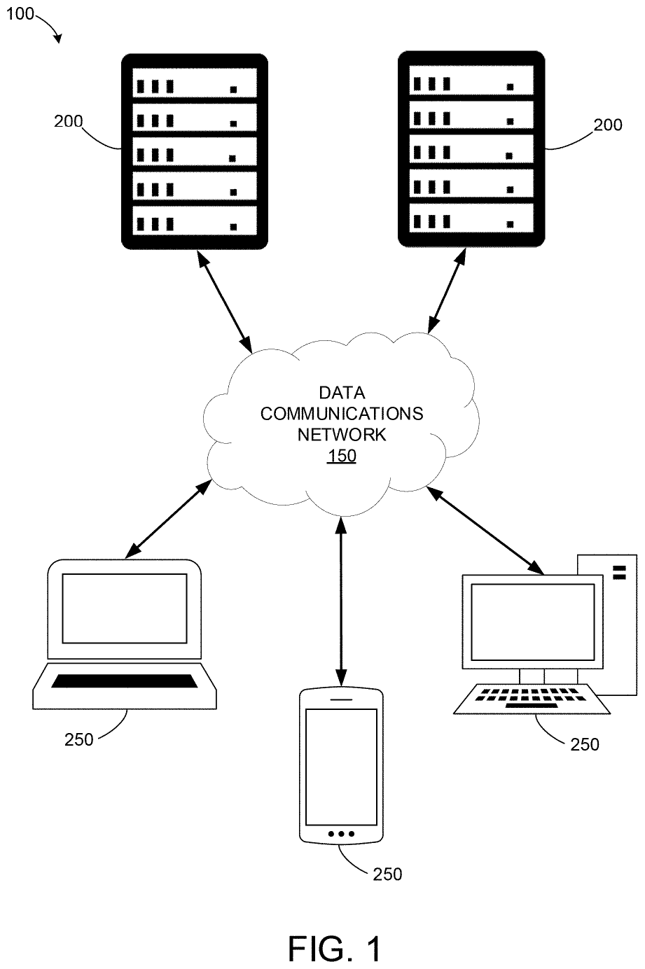

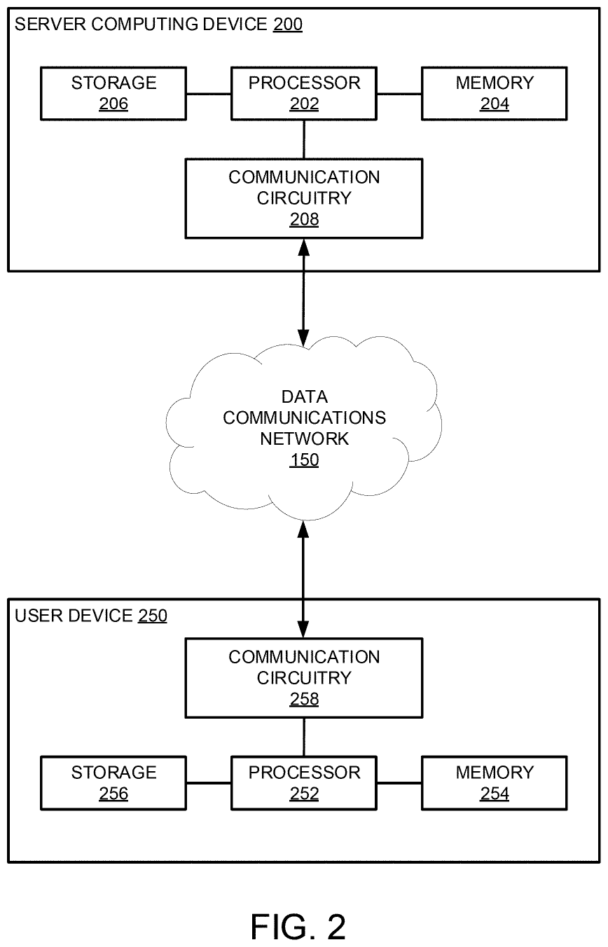

The systems and methods described herein can be implemented using a data communications network, server computing devices, and mobile devices. For example, referring to FIGS. 1 and 2, an exemplary communications system 100 includes data communications network 150, exemplary server computing devices 200, and exemplary user devices 250. In some embodiments, the system 100 includes one or more server computing devices 200 and one or more user devices 250. Each server computing device 200 can include a processor 202, memory 204, storage 206, and communication circuitry 208. Each user device 250 can include a processor 252, memory 254, storage 256, and communication circuitry 258. In some embodiments, communication circuitry 208 of the server computing devices 200 is communicatively coupled to the communication circuitry 258 of the user devices 250 via data communications network 150. Communication circuitry 208 and communication circuitry 258 can use Bluetooth, Wi-Fi, or any comparable data transfer connection. The user devices 250 can include personal workstations, laptops, tablets, mobile devices, or any other comparable device.

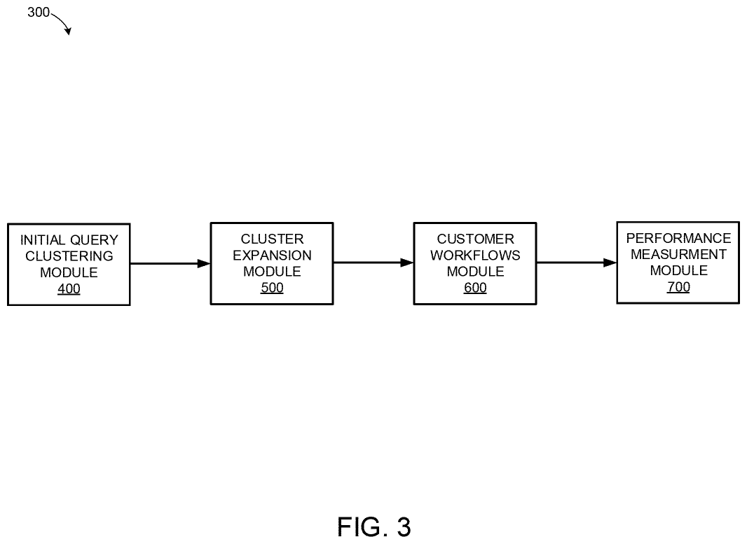

Referring to FIG. 3, an architecture 300 for measuring the impact of online search queries on customer actions includes initial query clustering module 400, cluster expansion module 500, customer workflows module 600, and performance measurement module 700. Architecture 300 looks at search query logs and groups search queries into homogeneous groups based on business organization. These groups are then aligned to business needs by mapping them to appropriate product and service buckets. These product and service buckets are mapped to the activities or jobs that can be done around these products and services. Architecture 300 can track search effectiveness by tracing back customer activity to the appropriate search area and search query.

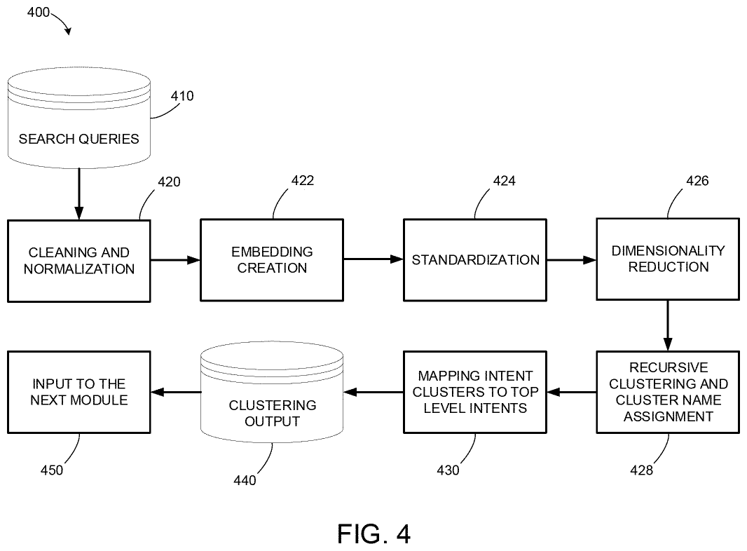

Referring to FIG. 4, the process steps involved in the initial query clustering module 400 is illustrated. Module 400 begins by taking search queries 410 as an input. The search queries 410 are then subjected to cleaning and normalization 420, followed by embedding creation 422, which represents the text from the search queries 410 numerically. Cleaning and normalization 420 involves removal of non-informative phrases, replacing acronyms with full names, removing repeated words or phrases, and removal of possible customer information, e.g. phone or account numbers. In some embodiments, embedding creation 422 uses a pre-trained language-based model, RoBERTa, to get the word/phrase embedding.

The output from embedding creation 422 undergoes standardization 424 and dimensionality reduction 426. Standardization 424 involves transforming the embedding such that the mean of the embedding becomes 0 and the variance becomes 1. Dimensionality reduction 426 involves using Principal Component Analysis to reduce the number of dimensions of the embedding while retaining the variance. For example, in some embodiments, the dimensions of the transformed embedding is reduced to 300 using Principal Component Analysis.

The output from dimensionality reduction 426 is used for recursive clustering and cluster name assignment 428, which is then used for mapping intent clusters to top level intents 430. Recursive clustering and cluster name assignment 428 involves using Agglomerative Hierarchical clustering recursively to cluster the search queries. A cluster is named after the most frequent occurring constituent search query. For example, in some embodiments, six levels of clusters are generated. Mapping intent clusters to top level intents 430 involves mapping the least granular cluster names to intents. For example, in some embodiments, the intents are business intents such as trade and invest. Some examples of cluster names that would map to a trade and invest business intent are early withdrawal, investor center, statement, transfer of assets, transfer tracker, and wire transform form. The output from 430 is stored in a clustering output database 440 and used as input to the next module 450. In some embodiments, the clustering output database 440 can be used to generate a user interface dashboard.

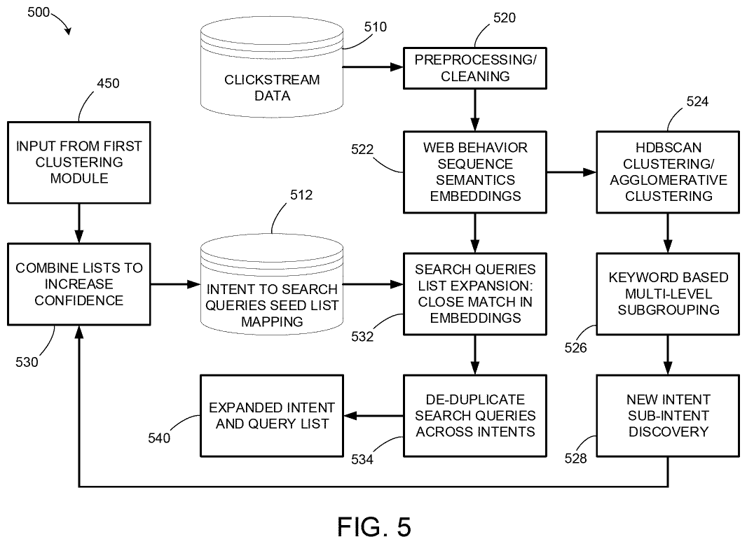

Referring to FIG. 5, the process steps involved in the cluster expansion module 500 is illustrated. Cluster expansion module 500 centers around an embedding representation space of the searches performed and the web pages visited by a user. The representation space is trained using the clickstream data and captures the search and page click behaviors of uses. For example, module 500 begins by retrieving clickstream data 510 from a database recording searches, web page visits, and related tags, and performing preprocessing/cleaning 520. Preprocessing/cleaning 520 involves removing high frequency page visits and extremely long sessions from bots, removing consecutive same page visits in a session, and the creation of a customer click and search journey.

Module 500 then continues with web behavior sequence semantic embeddings 522, which involves projecting pages and searches in embedding space such that the proximity of pages and searches in the space indicates semantic similarity. Module 500 continues with HDBSCAN clustering/agglomerative clustering 524, which involves grouping of related searches for a topic using a similarity metric and clustering algorithm which supports variable number of clusters. Module 500 continues with keyword based multi-level subgrouping 526, which involves defining hierarchy for each cluster based on word overlaps, and new intent sub-intent discovery 528, which involves using new clusters discovered which do not match the seed-list as new intents and hierarchies as sub intents.

Module 500 then proceeds to combine lists to increase confidence 530 by combining the input from first clustering module 450 and the new intents discovered to form a new seed-list. The new seed-list is stored in intent to search queries seed list mapping 512. Module 500 proceeds with search queries list expansion: close match in embeddings 532, which involves expanding the list of searches for each intent with close matching searches from the embeddings space. Before producing expanded intent and query list 540, module 500 proceeds with de-duplicate search queries across intents 534, which involves situations where the same search query appears in multiple intents. For such situations, module 500 keeps the one which has the highest similarity score with the seed search.

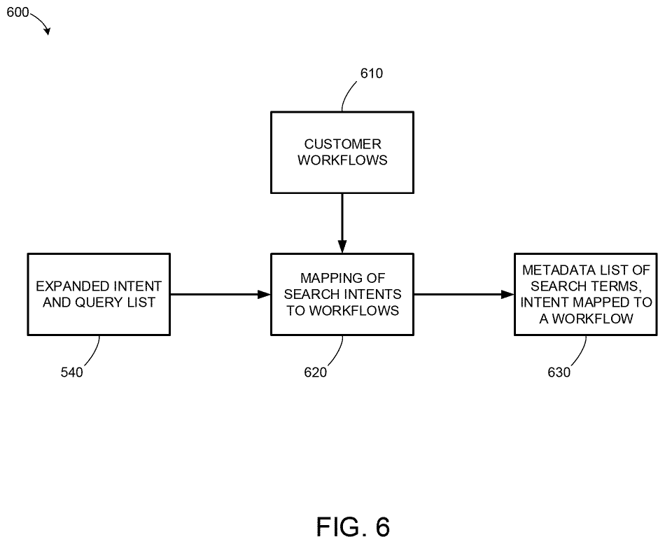

Referring to FIG. 6, the process steps involved in the customer workflows module 600 is illustrated. Module 600 begins by using the expanded intent and query list 540 from module 500 and customer workflows 610 for mapping of search intents to workflows 620. Customer workflows 610 represent the actions taken by a customer with respect to their relationship with an organization. The customer workflows 610 is based on Jobs to be Done theory and are organized through a lens known as the “consumption chain,” which considers all the various individual workflows that customers will undertake at one point or another during their lifecycle with the organization. Module 600 then produces a metadata list of search terms, intent mapped to a workflow (job) 630.

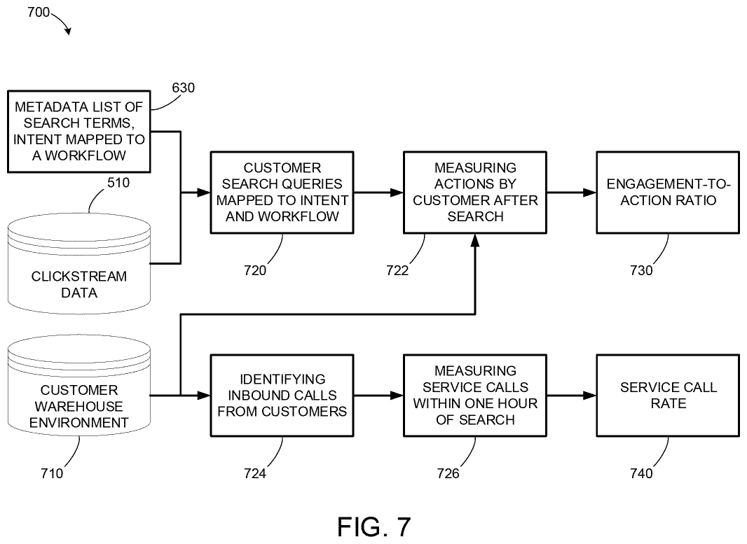

Referring to FIG. 7, the process steps involved in the performance measurement module 700 is illustrated. Module 700 begins by receiving customer warehouse environment 710 from a database containing information on customer actions like account conversions, bringing in new money, inbound calls, etc. Module 700 then proceeds to use the metadata list of search terms 630 from module 600 and clickstream data 510 to map queries searched by customers to respective workflows/actions based on the metadata at 720. Module 700 then proceeds to identify whether the customer has performed relevant actions after searching within the stipulated timeframe at 722.

Module 700 uses customer warehouse environment 710 to extract information about incoming calls made by customers to call representatives at 724. Similarly, module 700 proceeds to identify only service calls made by customers within one hour of performing a search at 726. Using this data, module 700 proceeds to calculate an engagement-to-action ratio 730 and a service call rate 740. The engagement-to-action ratio 730 provides information on what percentage of customers who performed a search went on to complete relevant actions within a stipulated timeframe. The service call rate 740 provides information on the percentage of searches that led to service calls made by customers within one hour of performing a search.

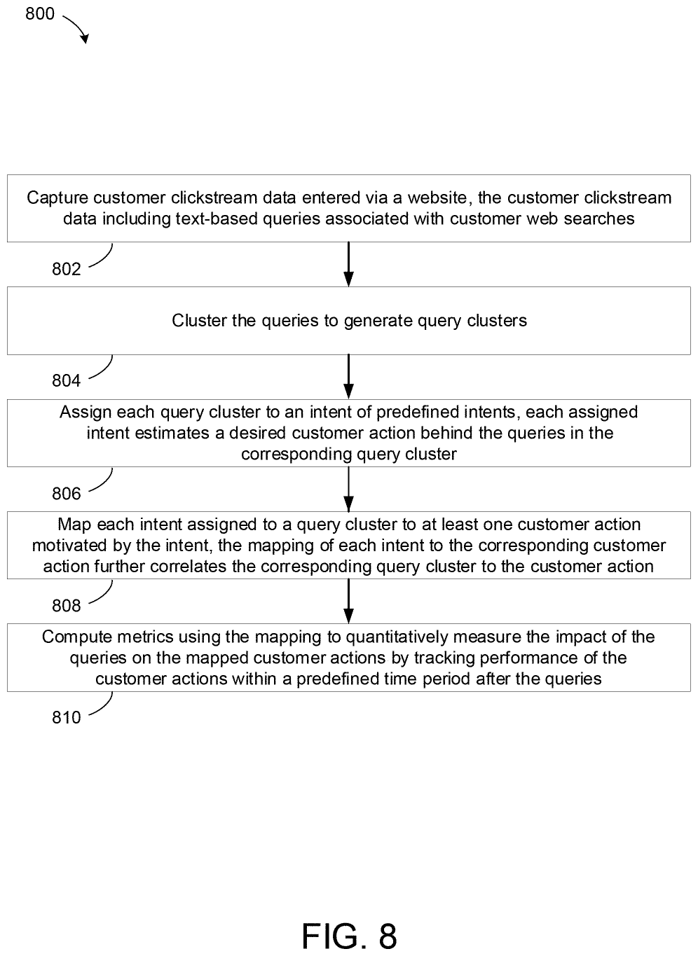

Referring to FIG. 8, a process 800 for measuring impact of online search queries on customer actions using architecture 300 includes capturing customer clickstream data entered via a website at step 802. The customer clickstream data includes text-based queries associated with customer web searches. Process 800 then proceeds by clustering the queries to generate query clusters at step 804. In some embodiments, clustering the queries involves performing Agglomerative Hierarchical clustering recursively to cluster the search queries. For example, in some embodiments, semantic similarity or cosine similarity between embeddings of search queries is used. In some embodiments, the embeddings are generated using RoBERTa. In some embodiments, there are six levels of clusters, each cluster named after the most frequently occurring constituent search query.

Process 800 proceeds by assigning each query cluster to an intent of pre-defined intents at step 806. Each assigned intent estimates a desired customer action behind the queries in the corresponding query cluster. Intent refers to the set of high level targets on which business can take actions. In some embodiments, intents are normalized and defined by stake-holders. For example, in some embodiments, the terms “early withdrawal,” “investor center,” “statement,” “transfer of asset,” come under the high-level business intent “trade and invest.” In some embodiments, assigning each query cluster to an intent includes naming each query cluster after a highest-occurring search query in that query cluster and assigning the intent to the query cluster based on the name of the query cluster.

In some embodiments, process 800 proceeds by expanding the query clusters by adding one or more new query clusters based on analysis of the customer clickstream data. For example, in some embodiments, expanding the query clusters includes analyzing the customer clickstream data to determine proximity of web pages and customer searches based on semantic similarity in an embedding space, grouping searches and web pages in near proximity to each other using a clustering algorithm to generate the one or more new query clusters, discovering new intents based on the one or more new query clusters, the new intents being different from the pre-defined intents, and adding the one or more new query clusters corresponding to the new intents to the query clusters corresponding to the predefined intents to expand the query clusters.

In some embodiments, clustering the queries includes cleaning and normalizing the text-based queries, numerically representing the cleaned and normalized text-based queries using an embedding creation technique to generate a plurality of embedding, and recursively clustering the plurality of embedding using a hierarchical clustering technique to generate the query clusters. For example, in some embodiments, cleaning the queries includes one or more of (i) removing non-informative phrases from the queries, (ii) expanding acronyms in the queries, (iii) removing repetitive words or phrases from the queries; and (iv) removing sensitive customer information from the queries.

In some embodiments, process 800 proceeds by transforming the embedding to create transformed embedding with numerical values in a range of 0 and 1 and reducing a number of dimensions of the transformed embedding using a principal component analysis technique, the recursive clustering being performed based on the transformed embedding with the reduced dimensionality. Process 800 then proceeds by mapping each intent assigned to a query cluster to at least one customer action motivated by the intent at step 808. The mapping of each intent to the corresponding customer action further correlates the corresponding query cluster to the customer action.

Process 800 finishes by computing metrics using the mapping to quantitatively measure the impact of the queries on the mapped customer actions by tracking performance of the customer actions within a predefined time period after the queries at step 810. In some embodiments, the metrics include an engagement-to-action ratio numerically quantifying a success rate for completing a customer action within the predefined time period that corresponds to a mapped query. For example, in some embodiments, computing the engagement-to-action ratio includes tracking customers who completed the customer action within the predefined time period after performing the search query corresponding to the customer action and computing the engagement-to-action ratio as a percentage of a number of the customers who performed the corresponding search query and completed the customer action within the predefined time period relative to a number of the overall customers who performed the corresponding search query.

In some embodiments, the metrics include a service call rate that quantifies a frequency at which customers engage with a call center within a predefined time period following performing a search query assigned to a search query cluster. For example, in some embodiments, computing the service call rate includes tracking inbound calls from customers within the predefined time period for services related to the search query and computing the service call rate as a percentage of a number of the inbound calls within the predefined time period relative to a number of search queries in the assigned search query cluster.

In some aspects, process 800 can be implemented on a system based on architecture 300 for measuring the impact of online search queries on customer actions. The system includes an input module configured to capture and process customer clickstream data entered via a website. The customer clickstream data including text-based queries associated with customer web searches. The system also includes an initial clustering module 400 configured to (i) cluster the queries to generate query clusters and (ii) assign each query cluster to an intent of pre-defined intents. Each assigned intent estimates a desired customer action behind the queries in the corresponding query cluster. In some embodiments, the initial clustering module assigns each query cluster to an intent by naming each query cluster after a highest-occurring search query in that query cluster and assigning the intent to the query cluster based on the name of the query cluster.

The system also includes a workflow module 600 configured to map each intent assigned to a query cluster to at least one customer action motivated by the intent. The mapping of each intent to the corresponding customer action further correlates the corresponding query cluster to the customer action. The system also includes a performance measurement module 700 configured to compute metrics using the mapping to quantitatively measure the impact of the queries on the mapped customer actions by tracking performance of the customer actions within a predefined time period after the queries.

In some embodiments, the system includes a cluster expansion module 500 configured to expand the query clusters by adding one or more new query clusters to the query clusters based on analysis of the customer clickstream data. For example, in some embodiments, the cluster expansion module 500 expands the query clusters by analyzing the customer clickstream data to determine proximity of web pages and customer searches based on semantic similarity in an embedding space, grouping searches and web pages in near proximity to each other using a clustering algorithm to generate the one or more new query clusters, discovering new intents based on the one or more new query clusters, the new intents being different from the predefined intents, and adding the one or more new query clusters corresponding to the new intents to the query clusters corresponding to the predefined intents to expand query clusters.

In some embodiments, the initial clustering module 400 clusters the queries by cleaning and normalizing the text-based queries, numerically representing the cleaned and normalized text-based queries using an embedding creation technique to generate a plurality of embedding, and recursively clustering the plurality of embedding using a hierarchical clustering technique to generate the query clusters.

In some embodiments, the metrics include an engagement-to-action ratio numerically quantifying a success rate for completing a customer action within the predefined time period that corresponds to a mapped query. For example, in some embodiments, the performance measurement module 700 is configured to compute the engagement-to-action ratio by tracking customers who completed the customer action within the predefined time period after performing the search query corresponding to the customer action and computing the engagement-to-action ratio as a percentage of a number of the customers who performed the corresponding search query and completed the customer action within the predefined time period relative to a number of the overall customers who performed the corresponding search query.

In some embodiments, the metrics include a service call rate that quantifies a frequency at which customers engage with a call center within a predefined time period following making a search query assigned to a search query cluster. For example, in some embodiments, the performance measurement module 700 is configured to compute the service call rate by tracking inbound calls from customers within the predefined time period for services related to the search query and computing the service rate as a percentage of a number of the inbound calls within the predefined time period relative to a number of search queries in the assigned search query cluster.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed:

1. A computer-implemented method for measuring impact of online search queries on customer actions, the method comprising:
capturing, by a computing device, customer clickstream data entered via a website, the customer clickstream data comprising a plurality of text-based queries associated with customer web searches;
clustering, by the computing device, the plurality of queries to generate a plurality of query clusters;
assigning, by the computing device, each query cluster in the plurality of query clusters to an intent in a plurality of pre-defined intents, wherein each assigned intent estimates a desired customer action behind the queries in the corresponding query cluster;
mapping, by the computing device, each intent assigned to a query cluster in the plurality of query clusters to at least one customer action motivated by the intent, wherein the mapping of each intent to the corresponding customer action further correlates the corresponding query cluster to the customer action; and
computing, by the computing device, a plurality of metrics using the mapping to quantitatively measure the impact of the queries on the mapped customer actions by tracking performance of the customer actions within a predefined time period after the queries.

2. The computer-implemented method of claim 1, further comprising expanding the plurality of query clusters by adding one or more new query clusters to the plurality of query clusters based on analysis of the customer clickstream data.

3. The computer-implemented method of claim 2, wherein expanding the plurality of query clusters comprises:
analyzing the customer clickstream data to determine proximity of web pages and customer searches based on semantic similarity in an embedding space;
grouping searches and web pages in near proximity to each other using a clustering algorithm to generate the one or more new query clusters;
discovering new intents based on the one or more new query clusters, wherein the new intents are different from the plurality of predefined intents; and
adding the one or more new query clusters corresponding to the new intents to the plurality of query clusters corresponding to the predefined intents to expand the plurality of query clusters.

4. The computer-implemented method of claim 1, wherein clustering the plurality of queries comprises:
cleaning and normalizing the plurality of text-based queries;
numerically representing the cleaned and normalized text-based queries using an embedding creation technique to generate a plurality of embedding; and
recursively clustering the plurality of embedding using a hierarchical clustering technique to generate the plurality of query clusters.

5. The computer-implemented method of claim 4, wherein the cleaning comprises one or more of (i) removing non-informative phrases from the plurality of queries, (ii) expanding acronyms in the plurality of queries, (iii) removing repetitive words or phrases from the plurality of queries; and (iv) removing sensitive customer information from the plurality of queries.

6. The computer-implemented method of claim 4, further comprising:
transforming the embedding to create transformed embedding with numerical values in a range of 0 and 1; and
reducing a number of dimensions of the transformed embedding using a principal component analysis technique,
wherein the recursive clustering is performed based on the transformed embedding with the reduced dimensionality.

7. The computer-implemented method of claim 1, wherein assigning each query cluster in the plurality of query clusters to an intent comprises:
naming each query cluster after a highest-occurring search query in that query cluster; and
assigning the intent to the query cluster based on the name of the query cluster.

8. The computer-implemented method of claim 1, wherein the plurality of metrics includes an engagement-to-action ratio numerically quantifying a success rate for completing a customer action within the predefined time period that corresponds to a mapped query.

9. The computer-implemented method of claim 8, wherein computing the engagement-to-action ratio comprises:
tracking customers who completed the customer action within the predefined time period after the performing the search query corresponding to the customer action; and
computing the engagement-to action ratio as a percentage of a number of the customers who performed the corresponding search query and completed the customer action within the predefined time period relative to a number of the overall customers who performed the corresponding search query.

10. The computer-implemented method of claim 1, wherein the plurality of metrics includes a service call rate that quantifies a frequency at which customers engage with a call center within a predefined time period following performing a search query assigned to a search query cluster.

11. The computer-implemented method of claim 10, wherein computing the service call rate comprises:
tracking inbound calls from customers within the predefined time period for services related to the search query; and
computing the service call rate as a percentage of a number of the inbound calls within the predefined time period relative to a number of search queries in the assigned search query cluster.

12. A computer-implemented system for measuring impact of online search queries on customer actions, the system comprising:
an input module configured to capture and process customer clickstream data entered via a website, the customer clickstream data comprising a plurality of text-based queries associated with customer web searches;
an initial clustering module configured to (i) cluster the plurality of queries to generate a plurality of query clusters and (ii) assign each query cluster in the plurality of query clusters to an intent in a plurality of pre-defined intents, wherein each assigned intent estimates a desired customer action behind the queries in the corresponding query cluster;
a workflow module configured to map each intent assigned to a query cluster of the plurality of query clusters to at least one customer action motivated by the intent, wherein the mapping of each intent to the corresponding customer action further correlates the corresponding query cluster to the customer action; and
a performance measurement module configured to compute a plurality of metrics using the mapping to quantitatively measure the impact of the queries on the mapped customer actions by tracking performance of the customer actions within a predefined time period after the queries.

13. The computer-implemented system of claim 1, further comprising a cluster expansion module configured to expand the plurality of query clusters by adding one or more new query clusters to the plurality of query clusters based on analysis of the customer clickstream data.

14. The computer-implemented system of claim 13, wherein the cluster expansion module expands the plurality of query clusters by:
analyzing the customer clickstream data to determine proximity of web pages and customer searches based on semantic similarity in an embedding space;
grouping searches and web pages in near proximity to each other using a clustering algorithm to generate the one or more new query clusters;
discovering new intents based on the one or more new query clusters, wherein the new intents are different from the plurality of predefined intents; and
adding the one or more new query clusters corresponding to the new intents to the plurality of query clusters corresponding to the predefined intents to expand the plurality of query clusters.

15. The computer-implemented system of claim 12, wherein the initial clustering module clusters the plurality of queries by:
cleaning and normalizing the plurality of text-based queries;
numerically representing the cleaned and normalized text-based queries using an embedding creation technique to generate a plurality of embedding; and
recursively clustering the plurality of embedding using a hierarchical clustering technique to generate the plurality of query clusters.

16. The computer-implemented system of claim 12, wherein the initial clustering module assigns each query cluster in the plurality of query clusters to an intent by:
naming each query cluster after a highest-occurring search query in that query cluster; and
assigning the intent to the query cluster based on the name of the query cluster.

17. The computer-implemented system of claim 12, wherein the plurality of metrics includes an engagement-to-action ratio numerically quantifying a success rate for completing a customer action within the predefined time period that corresponds to a mapped query.

18. The computer-implemented system of claim 17, wherein the performance measurement module is configured to compute the engagement-to-action ratio by:
tracking customers who completed the customer action within the predefined time period after the performing the search query corresponding to the customer action; and
computing the engagement-to action ratio as a percentage of a number of the customers who performed the corresponding search query and completed the customer action within the predefined time period relative to a number of the overall customers who performed the corresponding search query.

19. The computer-implemented system of claim 12, wherein the plurality of metrics includes a service call rate that quantifies a frequency at which customers engage with a call center within a predefined time period following making a search query assigned to a search query cluster.

20. The computer-implemented system of claim 19, wherein the performance measurement module is configured to compute the service call rate by:
tracking inbound calls from customers within the predefined time period for services related to the search query; and
computing the service call rate as a percentage of a number of the inbound calls within the predefined time period relative to a number of search queries in the assigned search query cluster.
